(19) United States
(12) Patent Application Publication
(10) Pub. No.: US 2020/0184501 A1
(43) Pub. Date: Jun. 11, 2020

(54) REACTIVE SHOW-SPECIFIC GAME SHOW PROCESS AND SYSTEM

(71) Applicant: Frank S. MAGGIO, Pinellas Park, FL (US)

(72) Inventor: Frank S. MAGGIO, Pinellas Park, FL (US)

(21) Appl. No.: 16/788,835

(22) Filed: Feb. 12, 2020

Related U.S. Application Data
(63) Continuation of application No. 14/834,379, filed on Aug. 24, 2015.
(60) Provisional application No. 62/041,065, filed on Aug. 23, 2014.

(51) Int. Cl. G06Q 30/02; G07F 17/32

(52) U.S. Cl. CPC G06Q 30/0209; G07F 17/3255; G06Q 30/0252; G06Q 30/0267; G07F 17/323

(57) ABSTRACT

A system and method are provided for enhancing consumer and/or customer awareness and attentiveness to advertising media presented in public forums by adding elements of reactive gamification to displays and presentations at tradeshows, fairs, amusement parks, sporting events and other like venues or activities that attract high levels of potential consumer and/or customer traffic. Media-based advertising and marketing strategies are implemented that uniquely provide consumer and/or customer interest in and attention to the live presentation by recognizing that Shows have audiences that generally pay little or no attention to some or all of the goods and services being exhibited, marketed, sold, or showcased. By adding elements of gamification, in the nature of a “Game Show” where prizes are awarded, and consumers are treated as contestants, a unique advertising environment is provided for presentation of the items advertised in the Show, generating increased interest and sales.

This application is a Continuation of U.S. patent application Ser. No. 14/834,379, entitled “Reactive Show-Specific Game Show Process And System,” by Frank S. Maggio, filed in the U.S. Patent and Trademark Office on Aug. 24, 2015, which in turn claims priority to U.S. Provisional Patent Application No. 62/041,065 entitled “Reactive Show-Specific Game Show Process And System,” by Frank S. Maggio, filed in the U.S. Patent and Trademark Office on Aug. 23, 2014, the disclosures of the previous applications being hereby incorporated by reference herein in their entirety.

### BACKGROUND

### 1. Field of the Disclosed Embodiments

This disclosure relates to systems and methods for enhancing consumer and/or customer awareness and attentiveness to advertising media presented in public forums by adding elements of reactive gamification to displays and presentations at tradeshows, fairs, amusement parks, sporting events and other like venues or activities that attract high levels of potential consumer and/or customer traffic.

### 2. Related Art

Advertisers, entrepreneurs, sales people and others make use of varying marketing tools and advertising materials to attract and hold the interest of potential customers, investors and the like. Many of these entities, as part of their integrated advertising strategies, participate in advertising activities at events specifically-designed to showcase certain marketplace sectors. These include national, regional and local trade shows, and particularly-targeted events such as, for example, boat shows, auto shows, RV shows, home improvement shows, craft shows and the like. Separately, local and national marketing entities, manufacturers, suppliers, dealers, sales entities and the like position samples of their products amid differing levels of advertising backdrops with informational and marketing/sales representatives at public venues to provide brand exposure and to create consumer and/or customer interest in the products. These public venues may include, but not be limited to: (1) sporting events stadiums, arenas and other venues, (2) concert and theatrical venues, (3) state, county or municipal fairs, carnivals and circuses, and (4) other like events and event venues. Virtually any public or private venue that is anticipated to have significant foot traffic can provide a simple scenario for brand exposure.

Differing strategies are employed depending on a size of a particular venue, and a makeup of potential advertisers at the particular venue. The advertising, sales and marketing “Midway” at any stock-car racing venue across the United States provides an example of such an advertising scheme. Automobile manufacturers, mobile telephone device companies, quick service restaurant and other food vendors, alcoholic and non-alcoholic beverage vendors, and other product marketing entities displaying and selling myriad products compete for customer and/or consumer attention in a particular city on a particular weekend when the proverbial circus comes to town.

Increasingly, technology-integrated displays are employed to provide eye-catching advertising materials in the competition for consumer and/or customer attention. Preferred positioning, high-tech displays, and many and widely varied advertising “gimmicks” may be employed to attract and retain, for more than a moment, a particular group of consumers' and/or customers' attention.

These efforts are undertaken as part of an integrated advertising campaign even as the advertising entities recognized that “advertising avoidance” has become nearly instinctive for many consumers and/or customers. Social media and internet-connected mobile devices increasingly provide alternative sources of attention-grabbing time segments, formerly occupied by marketing, promotions and advertising, even as potential consumers and/or customers are exposed to “live” advertising at the types of venues described above. The smart devices carried by consumers and/or customers, that run an entire spectrum of sophistication, are commonly thought of, or referred to, as “tools of distraction.” The ubiquity of these devices, however, poses an interesting possibility for implementing a uniquely improved advertising strategy involving customer and/or consumer immersion in the advertising, including active interaction with the advertising.

### SUMMARY OF DISCLOSED SUBJECT MATTER

In view of the above background, it may be advantageous to find some manner by which to integrate consumers' and/or customers' smart devices, including smartphones and tablets into a “live” advertising scheme provided at public venues with high consumer and/or customer foot traffic. Providing programming for these smart devices that may facilitate their employment to rewarding, challenging and interesting gamification related to, and/or in combination with, the “live” advertising and merchandising to which the significant foot traffic of a population of potential consumers and/or customers is exposed at these various venues, can actually stimulate a new degree of interest in the integrated commercial content.

Exemplary embodiments of the systems and methods according to this disclosure may provide unique integrated advertising schemes for employment in “physical” (and/or “virtual”) marketing venues, which may be referred to throughout this disclosure as “Shows.” In the context of this disclosure, the term “Show(s)” may be used to refer to a class of advertising scenarios such as those described above. These Shows may include trade shows, exhibits, home shows, auto shows, wedding shows, or even flea markets and bazaars, as well as encompassing advertising displays (in the manner described above) at sporting, concert, and municipal venues (including fairs). A Show may also be considered to include retail locations where products, product packaging, signage, and displays related to goods and services are exhibited, including, for example, home improvement stores, electronics stores, big-box stores and restaurants (traditional and quick service). Additionally, a Show may include a virtual exhibit of multiple, generally categorized goods and services, which may be aggregated, for example, on a web site, TV program, in print media, by direct mail, and in other known marketing schemes and media implementations that may be used to supplement live presentations directed at targeted and other audiences.

Exemplary embodiments may implement media-based advertising and marketing strategies that may uniquely provide consumer and/or customer interest in and attention to the live presentation by recognizing that Shows have audiences, many of whom may generally pay little or no attention to some or all of the goods and services being exhibited, marketed, sold, or showcased. By adding elements of gamification, in the nature of a “Game Show” such as those popularized over the decades on TV and online, where Game Show prizes are awarded, and consumers are treated as contestants, a unique and engaging, even enjoyable, advertising environment may be provided to the consumers of, and/or customers for, the items advertised in the Show, generating increased interest and sales that would not have otherwise resulted.

These and other features, and advantages, of the disclosed systems and methods are described in, or apparent from, the following detailed description of various exemplary embodiments.

### BRIEF DESCRIPTION OF THE DRAWINGS

Various exemplary embodiments of the systems and methods for enhancing consumer and/or customer awareness and attentiveness to advertising media presented in public forums by adding elements of reactive gamification to displays and presentations at tradeshows, fairs, amusement parks, sporting events and other like venues or activities that attract high levels of potential consumer and/or customer traffic, according to this disclosure, will be described, in detail, with reference to the following drawings, in which:

FIG. 1 illustrates a block diagram of an exemplary system for implementing an SGS scheme according to this disclosure; and

FIG. 2 illustrates a flowchart of an exemplary method for implementing an SGS scheme according to this disclosure.

### DETAILED DESCRIPTION OF EMBODIMENTS

The systems and methods for enhancing consumer and/or customer awareness and attentiveness to advertising media presented in public forums by adding elements of reactive gamification to displays and presentations at tradeshows, fairs, amusement parks, sporting events and other like venues or activities that attract high levels of potential consumer and/or customer traffic, according to this disclosure will generally refer to this specific utility for those systems and methods. Exemplary embodiments described and depicted in this disclosure should not be interpreted as being specifically limited to any particular physical configuration of a display, or reactive scheme as may be displayed, on a consumer or customer smart device, or to any particular class of consumer or customer smart device. It should be recognized that any advantageous use of the systems and methods for enhancing the consumer or customer integration into, immersion in or reactive engagement with live (or other) displays or informational presentations at a physical (or in a virtual) Show that may benefit from processes, techniques or schemes such as those discussed in detail in this disclosure is contemplated as being included within the scope of the disclosed exemplary systems and methods.

The systems and methods according to this disclosure will be described as being particularly adaptable to enhancing a live physical displays and presentations at myriad Shows (as defined above) with consumer- and/or customer-involved media reactive advertising to attract the attention of consumers and/or customers to displays of products and services and to hold the attention of those consumers and/or customers. The disclosed systems and methods may have the additional advantage of collecting demographic (and even personal) information regarding participating consumers and/or customers in a manner that provides an advertiser or marketer with a body of analyzable data regarding those consumers and/or customers in order to evaluate the effectiveness of the advertising schemes, and to provide a basis by which, for example, to modify those advertising schemes. In this regard, a class of Customer Intelligence (the variation on Business Intelligence) may be provided. Specific references to particular advertising schemes, and advertising scenarios, are meant to be illustrative only in providing examples of real-world utility for the disclosed systems and methods, and should not be considered as limiting the disclosed systems and methods to any particular product or combination of devices, or to any particular type of electronically or physically sharable data vehicle. In other words, any commonly-known physical and/or electronic advertising, informing and/or display component vehicles may be incorporated into the overall scheme for game applying advertising in a Show setting.

The disclosed exemplary embodiments of a Reactive Show-specific Game Show (SGS) Process and System may combine mass media, contesting, and reactive web-based and/or mobile device-implemented technology, in tandem with virtual or real Show venues, such as trade shows, home shows, exhibits and auto shows, to build business to consumer (“B2C”) or business to business (“B2B”) engagement, excitement and transactions around businesses engaged in traditional marketing, merchandising, advertising and the like at these show venues.

SGS may target Home Shows, Auto Shows, and Trade Shows in general. However, SGS can be applied to exhibits of all kinds, both B2C and B2B events. Sporting events that attract large audiences may provide marketers with display areas (such as for new automobiles, memorabilia, targeted consumer product marketing, and food seletions) that may be the topic of an SGS. SGS's may also apply to retail stores, outlet stores, as well as traditional or outlet malls—essentially, anywhere where goods or services are presented (via advertising and/or packaging) to the masses.

Reactive game shows are physical or virtual, live or on-demand quiz shows that ask consumers or potential customers as “contestants” to preview the products that are being presented in the Shows. The contestants are invited to enter on-demand or real-time reactive game shows, via their mobile devices or at advertiser presented kiosks, that test their knowledge of the products based on the information presented in the previews. Questions and queries may include questions that verify attention to the products, as well as optionally including general trivia or industry/vendor specific trivia. The games may include requirements to perform an action (email, tweet, etc.) in order to verify the contestants' attention or participation. Contestants may receive points for participating and/or for correctly answering the questions. Additional points may be awarded based on speed to answer correctly, and/or a particular contestant's frequency of play across a broad spectrum of product-related games using an application that may be, for example, stored in the contestant's mobile device.

In instances where there are more products than quiz questions, the game show may randomly serve a fixed number of queries about the products, so that over the game show period, all products receive similar levels of queries (e.g. 10 questions served from a pool of 20 questions about 20 products). Alternatively, some or all questions may only be asked about products featuring a special “alert” mark (such as a gaming or reacting logo), the use of which may allow the SGS host to collect a premium (as most or all queries may be tied to products displaying the alert). For example, 8 out of 10 questions may be asked about products that display the alert, and one to two questions may be asked about products that do not display the alert. These options allow advertisers and marketers to target their audience and collect considerable data regarding their potential customers' interests that was previously unavailable or at least not sufficiently “trackable” in a manner that would provide such extensive CI.

In one illustrative example, a consumer and/or customer may visit one or more display areas and/or exhibits at a Home Show. The display area or exhibit may include signage indicating one or more ways that the consumer or customer may be able to communicate regarding, and react to, the products being presented in a manner that is engaging, information-filled, and has the potential to dispense rewards for participation. The individual consumers and/or customers may approach a kiosk that is usable to react directly, or the individual consumers and/or customers, using their mobile devices may manually enter access information, or via some near-field communication with “active” signage, exchange information automatically to open the game to the consumer or customer now as a registered contestant. URLs, QR codes, or other access information may be presented on the signage to be visually read and manually entered in, optically scanned by or electronically exchanged with the prospective contestant's mobile device to start the reactive gaming process.

In another illustrative example, a website perhaps registered as, for example, HomeShowGameShow.com may provide a web domain that hosts a reactive game show, in support of exhibits, retailers, TV shows, websites, and direct mail campaigns, all Shows that may display, promote, merchandise, and/or sell home-related goods and services products. In an embodiment, entry to the Show may be presented as a “virtual home show” by an SGS promoter using, for example, a pack of 4×6 or similarly sized printed index cards featuring products for new and existing homes (brick pavers, home theater, screens, pools, cabinets, and the like). For example, organizations exist that send mass direct mail packs of cards to high end homes in blocks of cities around the United States. Franchise owners (or entire network of franchises) may employ the disclosed SGS technology to promote local or national advertiser packs.

In one example, each of approximately 16-40+ cards in a card pack may display a product germane to the needs of a new or existing homeowner—the same types of products, in other words, frequently found at “home show” exhibits popular at convention and exhibit halls around the country. These cards are a substitute for the signage that may be present in the physical convention or exhibit hall example above to which the balance of these details may apply equally.

Recipients of an SGS-powered direct mail pack, like the attendees as a “live” show, may be alerted by the signage (on the cover of the mailing or via other media promotion, advance mailings, email, website reminders, or the like) that a home show AND game show, offering exciting products, discounts, and other incentives, as well as a chance to enter an exciting game show for valuable prizes, awaits all who open the card pack or otherwise wish to participate via, for example, electronic means (e.g., a URL or QR code may be provided on the wrapper of the card pack). The cover of the mailer may display lists or images of prizes that might be won, a cumulative value of the savings being offered, and the QR code and/or website link or “HomeShowGameShow.com” entry code that will launch a preview video about the card pack, how the SGS works, what can be won, and other information germane to contestants' participation. Entry codes may be limited according to an effective time window and/or a particular geographic location. According to this latter example, advertisers and merchants are becoming increasingly aware of a trend among the consumer or potential customer population. With an explosive proliferation of electronic and online purchasing options, there is an increasing segment of the consumer or potential customer population that, as compared to the comparatively time consuming (and sometimes costly and tiresome) effort required to visit a physical home show venue, and having to sort through dozens of vendor exhibits of little interest with little other incentive than to potentially take advantage of “show discounts” or show special pricing, there is an opportunity to provide to these consumers and/or potential customers a targeted selection through SGS of only the most compelling and exciting products. The selected products may then be presented quickly and colorfully at the convenience of the consumer and/or potential customer (optionally via web or mobile device as a well), and the disclosed SGS schemes may provide the products in an entertaining and informational/educational manner that entices attention through the provision of rewards for participating (including potentially elements of publicity for winning a particular game show).

For the “exhibitor,” the deployment of the disclosed SGS schemes may provide measurable heightened engagement and attention to the exhibitor's products and services by an increasing percentage of the consumer and/or potential customer population. Contestant engagement with the reactive components may tend, over time, to provide extended branding and relevant consumer audience immersion verification. The employment of the disclosed SGS scheme via a direct mail campaign may also provide cost-savings over supporting exhibits at physical venues (or may at least warrant a reduction in a size of a display, or a frequency of displaying, when it is determined, for example, that the direct mail SGS campaign provides successful results).

The disclosed SGS schemes may also provide higher fidelity demography and data validating attention from responses collected from registered users (contestants), easier lead generation via data provided by the SGS host. This is as compared to the traditional and somewhat inartful catch-as-catch-can process of having exhibit visitors at live events fill out entry forms, or scan or swipe costly cards, for manual or semi-automated compilation of the demography later off-site at a further cost). Additionally, the SGS exhibitor that opts to forego the live venue saves the cost of staffing at the physical show. To enhance consumer and/or potential customer excitement in the disclosed SGS schemes as they may be applied for home-related products, a tag line for the direct mail version may include: “We bring a Home Show and Game Show—to YOU.!™” (or “your mailbox,” “your living room,” “your front door,” or the like).

In a version of the Home Show SGS, merchants may pay for a portion of their entry costs to the SGS host in bartered goods, which may, for example, be used to seed the prize pool for the SGS. Alternatively, merchants may offset the premium for the alert display on their exhibit via barter. The benefit of such a model is that, when the direct mail pack is targeted, the prize pool consists of the products and services inside the mail pack thereby increasing interest in the SGS (and the merchants), further increasing the likelihood that the card pack is opened and then reviewed by targeted consumers and/or potential customers.

Because the direct mail material is supplemented with mobile and web information and alerts, the SGS host may also embed video (including commercials) into the SGS, so that merchants are able to promote products both in print and in video. The disclosed SGS schemes may incorporate traditional “interruptive” commercials inside the game, or the commercials can be made entirely “reactive,” so that heightened attention is paid to the commercials and the direct mail.

As noted above, there will likely remain a segment of the consuming population that through habit, comfort, or simply a desire for human interaction may still be drawn to the physical exhibit convention halls. Additionally, “other” events and event venues, including myriad sporting events, and state and local municipality fairs, remain significant opportunities for extensive consumer and/or potential customer foot traffic. It is for this reason that a physical “venue-based” version of the virtual direct mail example, above, may be employed. In embodiments, such a venue-based version may be employed to enhance a traditional home show (i.e. the City X Home Show), with the disclosed SGS schemes. In such an example, a home show promoter may provide “premium” exhibitors with the ability to enhance their exhibits with a reactive SGS, while also promoting the SGS to event attendees.

Event attendees may access the SGS via a reactive web host like ReacTV, via a QR-enabled mobile game accessed at the entry of the venue or particular exhibits, via reactive mobile or web applications like the React app, or utilizing dedicated tablets or kiosks that may be formatted to allow for registration and SGS play at the same time. A dedicated reactive application may be made available to attendees. To ensure game play takes place only during the show, at the venue, or according to other such selectable restrictions, the show host could require entry take place using special tablets or data entry kiosks. Other means of “locking down” users so that they are in attendance could include requiring a show-specific or user-specific password be used to access the game (such as one provided when registering to attend or otherwise that may only be available within the confines of the venue).

In embodiments, actual live show attendees may be alerted that certain exhibitors are participating in the Home Show Game Show, where paying attention to their exhibits and products might increase the chance of winning prizes. Attendees may be able to recognize participating merchants via the display of an alert at the exhibits of the participating merchants, for example.

In these embodiments, similar to the virtual direct mail Home Show SGS, the venue/show host/promoter may offer exhibitors with a premium marketing opportunity to include being featured in the SGS, along with the right to display the reactive alert on their exhibit, on the exhibit floor map, on signage and/or on any collateral advertising or merchandising materials, as appropriate. This premium may be “cashed in” to acquire early registration, or be added to incentivize the sale of difficult to sell or premium-priced display inventory, ads inside of the show's magazine, or a bundled media package.

In embodiments, access to an online or mobile application for a disclosed reactive SGS may be enabled in myriad ways. These may include manual entry of a URL, automated entry of the URL triggered by an optically-scannable QR code or recovery of a special code required to access the SGS from inside a web site or mobile app (such as the React app), or via other automated data exchange methods. A native application or mobile web-based application may include programming designed to support a SGS. A reactive application (like the React app) may launch the SGS game simply through the entry of a unique code associated with the particular SGS game inside the application. In embodiments, therefore, a single application on one's mobile device may support and launch any authorized SGS. The application may, for example, compare an entered code to a list of valid and supported reactive games (which may be either or both of time and location limited), and launch the SGS, whether as a web application, or as a native version of the SGS.

In one version of the SGS scheme, users could be served game questions one at a time, after entry. The gamification may take on aspects of a mobile device controlled scavenger hunt as contestants (visitors or users) may be directed to locate many or all of the merchants, products, or exhibitors in order to maximize a contestant's score in the gamified SGS. This process may interestingly provide ancillary benefit to other non-participating (non-reactive) vendors within the virtual or physical Show environment, as the searching process provides additional exposure and branding opportunities to all advertisers in the SGS-enabled virtual or physical Show.

In embodiments, Shows may be supported by the disclosed SGS schemes in retail outlets, including grocery stores, outlet stores, big box stores, home improvement outlets, malls, restaurants (quick service or traditional), convenience and drug stores. Any retail location that displays mass merchandise, displays or uses physical or digital menus to alert consumers and/or customers to “advertised merchandise, utilizes shelves with unique displays and/or signage and the like, may benefit from implementation of the disclosed SGS schemes to entice consumers to pay heightened attention to goods and services being sold at the retail location. Additional retail-related elements eligible for gamification could include direct mail, newspaper-inserted, or in-store fliers or magazines that promote items being sold (and often discounted) at the retail location. Similar to a trade show or exhibit, visitors to the retail outlet could be provided with an in-store or online promotional insert, with some or all items specially marked with an alert that invites closer attention, and which may increase the likelihood of that item being featured in the SGS. Once in the retail location, the consumers and/or customers may be prompted by signage to launch the SGS application which allows them to answer questions concerning the products and recover certain rewards for participation and interest in particular products. The rewards could be made available generally by the retail location regardless of whether an individual contestant purchase a particular highlighted product or not.

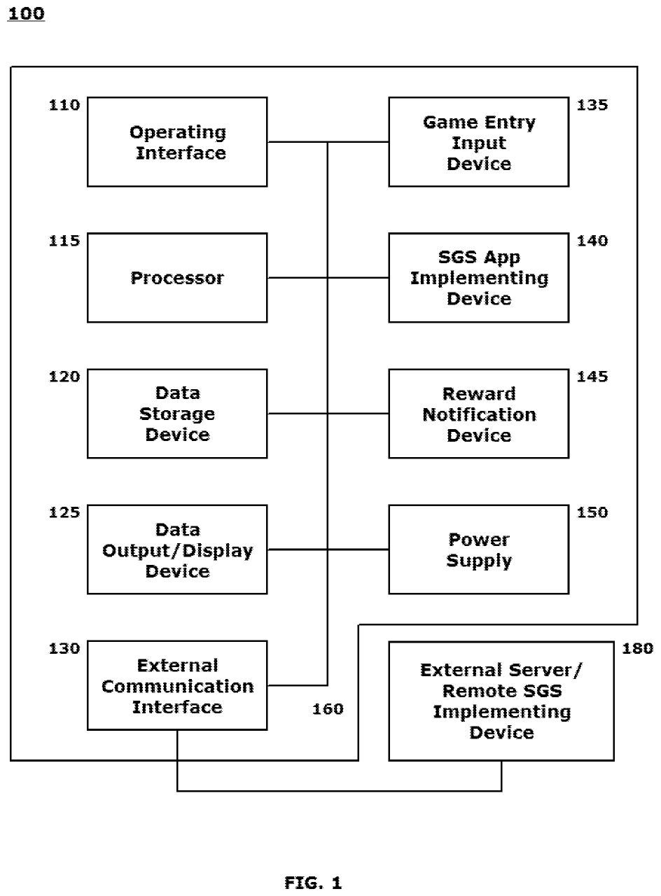

FIG. 1 illustrates a block diagram of an exemplary (mobile device) system 100 for implementing an SGS scheme according to this disclosure.

The exemplary system 100 may include an operating interface 110 by which a user may communicate with the exemplary system 100. The operating interface 110 may provide a user an opportunity to manually input access code or other information necessary to initiate participation in the SGS (physical at a live venue) or virtual (on, for example, a web-based application). The other information may include a particular geographic location and/or other information regarding the user, particularly in the virtual Show scenario where location and identification of a user may not be otherwise verifiable. In this regard, automated geolocating capability for the mobile device may be employed. The operating interface 110 may be configured as one or more conventional mechanisms common to computing and/or communication devices that may permit a user to input information to the exemplary system 100. The operating interface 110 may include, for example, a conventional keyboard, a touchscreen with “soft” buttons or with various components for use with a compatible stylus, a microphone by which a user may provide oral commands to the exemplary system 100 to be “translated” by a voice recognition program, or other like device by which a user may communicate specific operating instructions to the exemplary system 300.

A consumer or customer carrying his or her mobile device as the exemplary system 100 at a trade show may a consumer might visit a booth hosted by a manufacturer, supplier or merchant, and after reviewing the marketing materials, the consumer or customer may be asked to may be asked to visit a URL on the mobile device. The URL may be manually entered via the operating interface 110.

The exemplary system 100 may include one or more local processors 115 for individually operating the exemplary system 100 and for carrying into effect the implementation of the SGS scheme in the exemplary system 100. The processor 115 may carry out routines appropriate to operation of the device and may undertake data manipulation and analysis functions appropriate to the game. Processor(s) 115 may include at least one conventional processor or microprocessor that interprets and executes instructions to direct specific functioning of the exemplary system 100, and control of the SGS gamification implementation according to this disclosure.

The exemplary system 100 may include one or more data storage devices 120. Such data storage device(s) 120 may be used to store data or operating programs to be used by the exemplary system 100, and specifically the processor(s) 115 in carrying into effect the various data receiving, comparing, reactive game playing and rewards notification functions of the disclosed SGS schemes. At least one of the data storage device(s) 120 may be used to store the gamification application (which may be the React app). The data storage device(s) 120 may include a random access memory (RAM) or another type of dynamic storage device that is capable of storing updatable database information, and for separately storing instructions for execution of system operations by, for example, processor(s) 115. Data storage device(s) 120 may also include a read-only memory (ROM), which may include a conventional ROM device or another type of static storage device that stores static information and instructions for processor(s) 115. Further, the data storage device(s) 120 may be integral to the exemplary system 100, or may be provided external to, and in wired or wireless communication with, the exemplary system 100, including as cloud-based storage components.

The exemplary system 100 may include at least one data output/display device 125, which may be configured as one or more conventional mechanisms that output information to a user. The data output/display device 125 may be used to indicate, in sequence, the following displays. First, the data output/display device 125 may display a field for manual input and acceptance of a game code. Next, the data output/display device 125 may display an SGS Welcome Screen, providing branding and inviting the contestant to start the game. In instances where a particular contestant, and the contestant's mobile device may have been pre-identified to, for example a reactive gaming application, the Welcome Screen may identify the contestant. A next screen may, for example, be in a form of an introductory element to provide the contestant with instructions on how to play. The SGS may display a video component or video content regarding the product or products beyond those that may actually be present at the Show. An automobile or boat dealer, for example, may display at the Show samples of its NEW inventory. Other elements may be displayable once the contestant is in the game to include samplings from the dealer's USED inventory. The data output/display device 125 may display, for example, a video advertisement, or simple displays and banners, to supplement the SGS, or that might be sponsored by another advertiser. The gamified presentation may then commence, or to provide time for a user to adjust screen size or make other inputs on the mobile device, a post-video instruction screen can provide more information about how to play and what to expect—akin to the instructions provided on a Game Show. Next, the data output/display device 125 may display a typical “reactive” quiz question that contains information from the in-game ad or exhibit at the Show. Separately, The SGS can also poll the contestants, allowing the merchant or sponsor to gain insights on consumer sentiment, purchase intent, and reviews, thereby building CI.

Lead generation from educated consumers who demonstrate their knowledge of the goods and services, and express an interest in being contacted, is an extremely valuable benefit of SGS. A Next screen in sequence may display an electronically fillable form to collect information as the merchant or sponsor may desire. These additional entries may be separately incentivized allowing contestants to receive additional discount coupons, samples, sales incentives, or even to facilitate purchase a product or contracting for a service.

At an end of a particular “game,” contestants may be prompted to provide registration information to one or more of a number of useful purposes. The registration information may by typical identifying information including: first and last name; email address; and DOB, in order for the contestants to be ultimately registered in the prize pool, for example, and to see their scores. In embodiments, contestants may optionally be pre-registered in order to enter the SGS.

Scoring may be displayed then on the data output/display device 125. The display of the score may provide, and log, a completed registered entry with a score (points for correct answers), a grade (based on % of questions answered correctly), a percentile rank (contestant's score as a percent of the highest course score submitted to date), or according to any other like (usable) measure.

The exemplary system 100 may include one or more separate external communication interfaces 130 by which the exemplary system 130 may communicate with one or more offboard SGS implementing components including, but not limited to an external server (as a) remote SGS implementing device 180. Communications with the remote components will generally be by wireless communication pathways and/or links.

The exemplary system 100 may include an automated game entry input device 135. As indicated above, the game entry input device 135 may be in the form of an optical reader device for scanning barcodes, QR codes, glyphs and the like. Otherwise, the game entry input device 135 may comprise one or more devices or units for implementing near field communications with compatible powered information storage units that may be associated, for example, with merchant, advertising and/or exhibit signage or other marketing materials. The game entry input device 135 may be used to enter specific SGS gaming codes that may automatically identify a particular game, and also may cause, for example, an SGS app implementing device 140 to commence a particular SGS game application scheme in the exemplary system 100.

The exemplary system 100 may include an SGS app implementing device 140 that may execute functions for carrying into effect the SGS scheme in the exemplary system 100. The SGS app implementing device 140 may itself be a function of the processor 115, or may exist in the exemplary system 100 as a stand-alone component.

The SGS app implementing device 140 may accept particular entry information including a game code to commence a particular game. In embodiments, the SGS app implementing device 140 may compare an input code to a database, either in a local data storage device 120, or in a remote server 180, to identify the code as a valid game and initiating input. Once the game is initiated, the SGS app implementing device 140 may cause a video or other content to be displayed on the data output/display device 125 for the contestant to watch and/or study. The SGS app implementing device 140 may then cause a series of questions to be presented on the display and accept answers from the user to each of the series of questions. In embodiments in which the games, or responses, are timed, the SGS app implementing device 140 may display a timer associated with each question, or with the game overall. Once all of the questions have been presented, and answers attempted, or upon the lapse of an elapsed time for the game, the SGS app implementing device 140 may stop the game and calculate an overall score. The SGS app implementing device 140 may initiate collection of identification information from the contestant in connection with registering the contestant's score. The identification information and the contestant's score may be communicated via the external communication interface 130 to the external server/remote SGS implementing device 180 to determine, for example, where a particular contestant's score may place that contestant with respect to the overall population of contestants having participated in the game during a particular time window which the SGS implementing device 140 may specify.

The exemplary system 100 may include a reward notification device 145 by which, when a contestant is determined to have won a prize, award, reward or the like, in the form of, for example, merchandise, discounts, coupons and/or other incentives, a reward notification device 145, which may be a function of the processor 115, or a stand-alone device, may present reward information on the data output/display device 125. Otherwise, the reward notification device 145 may send, for example, an email or a text message to the contestant at one or more of the contestant's registered “addresses.”

The exemplary system 100 may include some manner of power supply 150 by which to supplement or recharge an onboard power supply in the exemplary system 100.

All of the various components of the exemplary system 100, as depicted in FIG. 1, may be connected internally, and to one or more external components by one or more data/control busses 160. These data/control busses 160 may provide wired or wireless communication between the various components of the exemplary system 100, whether all of the components of the exemplary system 100 are housed integrally in, or are otherwise external and connected to the exemplary system 100.

The exemplary system 100, as a whole, or any of the input/output components associated with the exemplary system 100, including the operating interface 110, the data output/display device 125, one or more external communication interface(s) 130, the game entry input device 135 and/or the reward notification device 135, may comprise user-wearable devices such as, for example, wearable computer/communicating display glasses and/or watches, biometric sensors, virtual reality (or immersion) devices including goggles, helmets, tactile gloves and the like, and other known or developed wearable components for carrying out one or more of computing and/or communicating functions.

It should be appreciated that, although depicted in FIG. 1 as an essentially integral unit, the various disclosed elements of the exemplary system 100 may be arranged in any combination of sub-systems as individual components or combinations of components, integral to a single unit, or external to, and in wired or wireless communication with the single unit of the exemplary system 100. Wireless communications may be by RF radio devices, optical interfaces, NFC devices and other wireless communicating devices according to RF, Wi-Fi, WiGig and other like communications protocols. In other words, no specific configuration as an integral unit, or as a support unit, is to be implied by the depiction in FIG. 1. Further, although depicted as individual units for ease of understanding of the details provided in this disclosure regarding the exemplary interface and control system 100, it should be understood that the described functions of any of the individually-depicted components may be undertaken, for example, by one or more processors 115 connected to, and in communication with, one or more data storage device(s) 120.

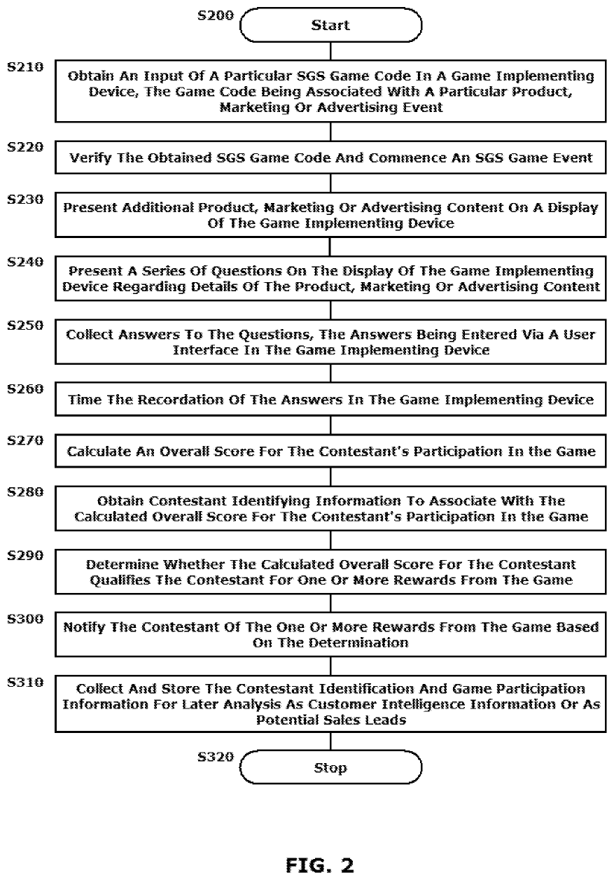

The disclosed embodiments may include an exemplary method for implementing an SGS scheme according to this disclosure. FIG. 2 illustrates a flowchart of such an exemplary method. As shown in FIG. 2, operation of the method commences at Step S200 and proceeds to Step S210.

In Step S210, an input of a particular SGS game code may be obtained in a game implementing device. The game code may be associated with a particular product, marketing or advertising event, at a physical or virtual location in the manner described above. The game code may be obtained, for example, by visual inspection of signage at the particular exhibit of the product, marketing or advertising event. Separately, the game code may be optically scanned and automatically entered in the game implementing device by reading, for example, a QR code, a barcode, or other visual representation of a particular code by the game implementing device. In embodiments, the game code may be received in the game implementing device by near field communication with cooperating elements associated with the product, marketing or advertising event. Operation of the method proceeds to Step S220.

In Step S220, the obtained SGS game code may be verified and an SGS game of that automatically commenced. This verification may occur by, for example, comparing the obtained SGS game code with a list of applicable, approved, and/or authorized SGS game codes recorded, for example, in a local or remote database. A particular SGS game code may be associated with a specific game, a family of games, or game access in general. As noted above, a particular SGS game code may be time and/or location limited. In embodiments, an indication that the SGS game code has been verified may be presented on a display component of the game implementing device and an additional manual input from a user may be required in order to start the game event. Operation of the method proceeds to Step S230.

In Step S230, additional product, marketing or advertising content may be presented on a display of the game implementing device as a part of the game event. Operation of the method proceeds to Step S240.

In Step S240, a series of questions may be presented on the display of the game implementing device regarding details of the product, marketing or advertising content, or otherwise with respect to specific details that may be obtained from, for example, marketing materials available in a live exhibit at a physical event with which the game is associated. Operation of the method proceeds to Step S250.

In Step S250, answers may be collected electronic to the questions as presented. The answers being available in the advertising content or marketing materials. In implementations, the answers to the questions will be entered via an operating interface associated with the game implementing device. Operation of the method proceeds to Step S260.

In Step S260, a timer may be usable to time the recordation of the answers in the game implementing device. An ability of a particular contestant to enter answers to the questions within a limited amount of time provides an indication of the interest that the contestant paid to the products marketing or advertising, and/or to the additional product, marketing and/or advertising information displayed as a part of the game. Operation of the method proceeds to Step S270.

In Step S270, an overall score for the contestant's participation in the game event may be calculated. The overall score may be weighted, for example, by the time that it took to complete each question, or the entire series of questions. Operation of the method proceeds to Step S280.

In Step S280, contestant identifying information, if not previously received, may be obtained to associate with the calculated overall score for the contestant's participation in the game event. Operation of the method proceeds to Step S290.

In Step S290, a determination may be made whether the calculated overall score for the contestant qualifies the contestant for one or more rewards from the game event. This determination may be made according to a set of rules for the game presented to the contestants prior to engaging in the game event, and may be randomized in some manner to ensure that a number of rewards does not exceed a number of rewards available in an overall prize pool. Operation of the method proceeds to Step S300.

In Step S300, a contest and may be notified of the one or more rewards from the game event based on the determination. Such notification may come on the game implementing device. Otherwise, the contestant may be notified in any other reasonable manner by which such notifications are traditionally undertaken including direct mail, email, SMS text messages, telephone calls or the like. Operation the method proceeds to Step S310.

In Step S310, contestant identification and game participation information for the contestants may be collected and stored for later analysis. Such analysis may provide a basis for potential sales leads, or may be analyzed according to a particular event sponsor or marketer/exhibitor needs in order to provide detailed customer intelligence by which, for example, an entity may evaluate the effectiveness of its advertising and/or marketing schemes. A compilation of contestants and SGS responses may be provided to an event sponsor in a downloaded format (CSV or customer reports). Optional prize selection and acquisition, finalist selection, winner validation, prize fulfillment, and customized reporting services can be provided by outside vendors, or may be conducted by an SGS host company. Operation of the method proceeds to Step S320, where operation of the method ceases.

The disclosed embodiments may include a non-transitory computer-readable medium storing instructions which, when executed by a processor in a game implementing device, may cause the processor to execute all, or at least some, of the steps of the method outlined above.

The above-described exemplary systems and methods reference certain conventional components to provide a brief, general description of suitable operating and presentation scheme implementing environments in which the subject matter of this disclosure may be undertaken for familiarity and ease of understanding. Although not required, embodiments of the disclosure may be provided, at least in part, in a form of hardware circuits, firmware, or software computer-executable instructions to carry out the specific functions described. These may include individual program modules executed by processors.

Those skilled in the art will appreciate that other embodiments of the disclosed subject matter may be practiced in myriad configurations for carrying into effect the disclosed SGS schemes with applications hosted on a broad spectrum of computing and communicating devices including, but not limited to, smart phones, tablets, portable computers and other like devices.

As indicated above, embodiments within the scope of this disclosure may include computer-readable media storing computer-executable instructions or data structures that can be read and executed by one or more processors for controlling the presentation processes and schemes. Such computer-readable media can comprise RAM, ROM, EEPROM, CD-ROM, flash drives, data memory cards or other analog or digital data storage device that can be used to carry or store desired program elements or steps in the form of accessible computer-executable instructions or data structures.

Computer-executable instructions include, for example, non-transitory instructions and data that can be executed and accessed respectively to cause a processor, for example, in an SGS game implementing device to perform certain of the above-specified data acquisition, game implementation, and display functions. Computer-executable instructions may also include program modules that are remotely stored for access and execution by a processor.

The exemplary depicted sequence of executable instructions or associated data structures represent one example of a corresponding sequence of acts for implementing the functions described in the steps of the above-outlined exemplary method. The exemplary depicted steps may be executed in any reasonable order to carry into effect the objectives of the disclosed embodiments. No particular order to the disclosed steps of the method is necessarily implied by the depiction in FIG. 2, except where a particular method step is a necessary precondition to execution of any other method step. Separately, not all of the depicted steps of the method shown in FIG. 2 need to be implemented in any particular embodiment.

Although the above description may contain specific details, they should not be construed as limiting the claims in any way. Other configurations of the described embodiments of the disclosed systems and methods are part of the scope of this disclosure. It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

We claim:

1. A system for implementing a reactive game, comprising:
an input device that obtains a particular event code to grant access of a contestant to a reactive game;
a display device for displaying information regarding the reactive game;
a gamification device that is configured to
direct display of information regarding the reactive game on the display device, the displayed information including advertising content for one of a product or an event;
direct display of a plurality of queries on the display device regarding details of the displayed information;
obtain answers in the gamification device from the contestant in response to each one of the plurality of queries displayed on the display device;
score the obtained answers;
determine whether the score qualifies the contestant for a reward; and
direct notification of contestant as to any qualification for a reward based on the determination.
